(19) United States
(12) Patent Application Publication
(10) Pub. No.: US 2021/0142594 A1
(43) Pub. Date: May 13, 2021

(54) AUTOMATIC DAILY INSPECTION SYSTEM

(71) Applicant: DENSO CORPORATION, Kariya-city (JP)

(72) Inventor: Koji SAKAI, Kariya-city (JP)

(21) Appl. No.: 17/157,528

(22) Filed: Jan. 25, 2021

Related U.S. Application Data
(63) Continuation of application No. PCT/JP2019/029292, filed on Jul. 25, 2019.

(30) Foreign Application Priority Data
Aug. 21, 2018 (JP) 2018-154839

(51) Int. Cl. G07C 5/08; G01M 17/007; G07C 5/00

(52) U.S. Cl. CPC G07C 5/0808; G07C 5/008; G01M 17/007

(57) ABSTRACT

An automatic daily inspection system that automatically performs a daily inspection of an automobile includes an automatic daily inspection apparatus mounted on the automobile. The automatic daily inspection apparatus is configured to perform a daily inspection on the automobile at a predetermined point of time, and transmit a diagnosis result of the daily inspection to a transceiver held by a manager who manages the automobile.

### CROSS REFERENCE TO RELATED APPLICATION

The present application is a continuation application of International Patent Application No. PCT/JP2019/029292 filed on Jul. 25, 2019, which designated the U.S. and claims the benefit of priority from Japanese Patent Application No. 2018-154839 filed on Aug. 21, 2018. The entire disclosures of all of the above applications are incorporated herein by reference.

### TECHNICAL FIELD

The present disclosure relates to an automatic daily inspection system that automatically performs daily inspections of automobiles.

### BACKGROUND

In recent years, the development of automatic driving vehicles has been promoted. Automatic driving vehicles are expected to be used in a car sharing business or automatic rental business (hereinafter referred to as car sharing business, etc.). In addition, since automatic driving vehicles can automatically drive to their destinations, it is expected in the future that they will be used not only by an owner who has a driver's license but also by an owner who does not have a driver's license.

### SUMMARY

According to an example of the present disclosure, an automatic daily inspection system that automatically performs a daily inspection of an automobile is provided to include an automatic daily inspection apparatus mounted on the automobile. The automatic daily inspection apparatus is configured to perform a daily inspection on the automobile at a predetermined point of time, and transmit a diagnosis result of the daily inspection to a transceiver held by a manager who manages the automobile.

### BRIEF DESCRIPTION OF DRAWINGS

The objects, features, and advantages of the present disclosure will become more apparent from the following detailed description made with reference to the accompanying drawings. In the drawings:

FIG. 1 is a block diagram showing functions by an automatic driving vehicle equipped with an automatic daily inspection system according to a first embodiment;

FIG. 2 is a configuration diagram of the automatic daily inspection system according to the first embodiment;

FIG. 3 is a diagram showing an example of notification contents of a diagnosis result to a manager of an automobile;

FIG. 4 is a diagram showing an example of notification contents of a diagnosis result displayed on an in-vehicle monitor of an automobile;

FIG. 5 is a flowchart of a control process performed by an automatic daily inspection apparatus according to the first embodiment;

FIG. 6 is a flowchart of processing performed by a manager of an automobile according to the first embodiment;

FIG. 7 is a block diagram showing functions of an automatic driving vehicle equipped with an automatic daily inspection system according to a second embodiment;

FIG. 8 is a flowchart of a control process performed by an automatic daily inspection apparatus according to a third embodiment;

FIG. 9 is a flowchart of a control process performed by an automatic daily inspection apparatus according to a fourth embodiment;

FIG. 10 is a flowchart of a control process performed by the automatic daily inspection apparatus according to a fifth embodiment; and

FIG. 11 is a flowchart of a control process performed by an automatic daily inspection apparatus according to a sixth embodiment.

### DETAILED DESCIPTION

Embodiments of the present disclosure will now be described with reference to the drawings. In the following embodiments, the same or equivalent parts are denoted by the same reference numerals as each other, and explanations will be provided to the same reference numerals.

### First Embodiment

A first embodiment will be described with reference to the drawings. The automatic daily inspection system of the present embodiment automatically performs a daily inspection of a automatic driving vehicle 1. The automatic driving vehicle 1 is an automobile in which an automatic driving system performs all driving operations such as acceleration, steering, braking, and monitoring of the surroundings.

In the present embodiment, the automatic driving vehicle 1 in which the automatic daily inspection system automatically performs a daily inspection will be described as being used for a car sharing business or an automatic rental business (hereinafter, referred to as a car sharing business etc.). However, the automatic driving vehicle 1 is not limited to those used for car sharing business, etc., but may be used by owners who have driver's licenses or owners who do not have driver's licenses. In the following explanation, the “manager” refers to (i) a business operator who conducts a car sharing business etc., of the automatic driving vehicle 1, (ii) a user of the automatic driving vehicle 1, (iii) an owner of the automatic driving vehicle 1, and (iv) a central management center that manages the automatic driving vehicle 1.

First, functions of the automatic driving vehicle 1 will be described with reference to FIGS. 1 and 2. The automatic driving vehicle 1 is equipped with various functions such as a traveling function 2, an air conditioning function 3, an accessory function 4, a service function 5, and an automatic daily inspection function 6.

The traveling function 2 is a function used for an automatic traveling of the automatic driving vehicle 1. Specifically, the traveling function 2 includes an automatic traveling camera 21, an automatic traveling radar 23 (for example, a laser radar), a steering device 22, a traveling motor, an engine, and the like.

The air conditioning function 3 is a function for air conditioning the interior of the vehicle. Specifically, the air conditioning function 3 includes an HVAC (abbreviation for Heating Ventilation and Air-Conditioning), a refrigeration cycle, a heat pump cycle, and the like. Further, the air conditioning function 3 may include an air conditioning monitor that displays an air conditioning state in the vehicle.

The accessory function 4 includes an audio device, a navigation system, and the like. The service function 5 includes a diagnosis and the like used at a dealer's service station and the like. The automatic daily inspection function 6 is a function that automatically performs daily inspections of the automatic driving vehicle 1. Specifically, the automatic daily inspection function 6 includes an automatic daily inspection apparatus 10 that performs a daily inspection of the automatic driving vehicle 1 at a predetermined point of time.

As shown in FIG. 2, the automatic daily inspection apparatus 10 is connected with an automatic traveling camera 21, a steering device 22, an air conditioning device 30, various sensors 40, and the like, via an in-vehicle LAN (Local Area Network) such as CAN (i.e., Controller Area Network) communication. As a result, the automatic daily inspection apparatus 10 can perform daily inspections of those devices.

The targets to be inspected daily by the automatic daily inspection apparatus 10 include devices including an automatic driving system that executes automatic driving. When the automatic daily inspection apparatus 10 performs a daily inspection of the imaging range of the automatic traveling camera 21, the automatic traveling camera 21 is operated to inspect whether or not the automatic traveling camera 21 can image the entire movable range. Further, when the automatic daily inspection apparatus 10 performs a daily inspection of the operating range of the steering device 22, the steering device 22 is operated to inspect whether or not the steering device 22 can operate the entire movable range. Therefore, the targets to be inspected daily by the automatic daily inspection apparatus 10 include the devices that perform the automatic driving, the devices which are difficult to inspect during traveling and can be inspected while the vehicle is stopped. The automatic daily inspection apparatus 10 displays the diagnosis result of the daily inspection on the in-vehicle monitor 50 mounted on the automatic driving vehicle 1 through the in-vehicle LAN. Further, the automatic daily inspection apparatus 10 transmits the diagnosis result of the daily inspection to the transceiver held by the manager of the automatic driving vehicle 1 via the Internet or the like. The manager of the automatic driving vehicle 1 includes a central management center 60 that manages the automatic driving vehicle 1, a business operator 70 such as a car sharing business etc., and a user 80 thereof. The user 80 of the car sharing business etc., may be the owner of the automatic driving vehicle 1. That is, in the present specification, the user 80 of the car sharing business etc., includes both an owner of the automatic driving vehicle 1 and a person other than the owner.

Further, the transceiver via which the manager of the automatic driving vehicle 1 receives the diagnosis result of the daily inspection is, for example, a mobile terminal, a smartphone, a personal computer, or the like. FIG. 3 shows examples of the notification contents of the diagnosis result displayed on the screen of the transceiver 90 held by the manager of the automatic driving vehicle 1. In this example, the screen of the transceiver 90 shows whether the automatic traveling camera 21, the steering device 22, the air conditioning device 30, and various sensors 40 are normal or abnormal, respectively.

FIG. 4 shows examples of the notification contents of the diagnosis result displayed on the in-vehicle monitor 50 of the automatic driving vehicle 1. That is, the automatic traveling camera 21 is shown as being normal with a range. The steering device 22 is shown as being normal with an operating range. The air conditioning device 30 is shown as being normal with no abnormality. The various sensors 40 are shown as being normal with a range. The notification contents of the diagnosis result may be displayed (i) with only the determination of normality or abnormality, (ii) with numerical values or colors to show lowering of the accuracy due to aging deterioration or dirt, or (iii) with the replacement time. Further, the notification of the diagnosis result may be performed by using speeches.

Next, a control process performed by the automatic daily inspection apparatus 10 of the first embodiment will be described with reference to the flowchart of FIG. 5. In the following description, the automatic daily inspection apparatus 10 may be simply referred to as an “inspection apparatus 10”.

First, in step S10, the inspection apparatus 10 acquires the car sharing user information to be input to the automatic driving vehicle 1.

In step S20, the inspection apparatus 10 compares the user information to be input to the automatic driving vehicle 1 with the immediately preceding user information, and determines whether or not the user 80 has been changed. When it is determined that the user 80 has not been changed (that is, the determination No. in step S20), the process is ended. On the other hand, when it is determined that the user 80 has been changed (that is, the determination Yes in step S20), the process is shifted to step S30.

In step S30, the inspection apparatus 10 performs a daily inspection of each function and device included in the automatic driving vehicle 1. This daily inspection is performed while the automatic driving vehicle 1 is stopped. Next, in step S40, the inspection apparatus 10 notifies the central management center 60, which manages the automatic driving vehicle 1, of the diagnosis result of the daily inspection. That is, the inspection apparatus 10 transmits all the diagnosis results of the daily inspection to the central management center 60. Then, the central management center 60 receives all of the diagnosis result of the daily inspection.

Subsequently, in step S50, the inspection apparatus 10 determines whether or not there is an abnormality in the diagnosis result of the daily inspection. When the inspection apparatus 10 determines that there is an abnormality in the diagnosis result of the daily inspection (that is, the determination Yes in step S50), the inspection apparatus 10 shifts the process to step S60.

In step S60, the inspection apparatus 10 transmits that there is an abnormality in the diagnosis result of the daily inspection to the transceiver 90 of the business operator 70 and the user 80 of the car sharing business etc. Then, the business operator 70 and the user 80 receive that there is an abnormality in the diagnosis result of the daily inspection. If the business operator 70 and the user 80 find that there is an abnormality in the diagnosis result of the daily inspection at this point, they can make a reservation for using another automobile.

On the other hand, when the inspection apparatus 10 determines in step S50 that there is no abnormality in the diagnosis result of the daily inspection (that is, the determination No. in step S50), the process is shifted to step S70. Then, in step S70, the use of the automatic driving vehicle 1 is started. Next, in step S80, the inspection apparatus 10 determines whether or not the use of the automatic driving vehicle 1 has been completed. When the inspection apparatus 10 determines that the use of the automatic driving vehicle 1 has been completed (that is, the determination Yes in step S80), the inspection apparatus 10 shifts the process to step S90.

The processing in steps S90, S100, and S110 is substantially the same as the processing in steps S30, S40, and S50 described above. That is, in step S90, the inspection apparatus 10 performs a daily inspection of each function and device included in the automatic driving vehicle 1. Next, in step S100, the inspection apparatus 10 notifies the central management center 60, which manages the automatic driving vehicle 1, of the diagnosis result of the daily inspection.

Subsequently, in step S110, the inspection apparatus 10 determines whether or not there is an abnormality in the diagnosis result of the daily inspection. When the inspection apparatus 10 determines that there is an abnormality in the diagnosis result of the daily inspection (that is, the determination Yes in step S110), the inspection apparatus 10 shifts the process to step S60. In step S60, the inspection apparatus 10 transmits that there is an abnormality in the diagnosis result of the daily inspection to the transceiver 90 of the business operator 70 and the user 80 of the car sharing business etc. Then, the business operator 70 and the user 80 receive that there is an abnormality in the diagnosis result of the daily inspection. If the business operator 70 and the user 80 find that there is an abnormality in the diagnosis result of the daily inspection at this point, the business operator 70 and the user 80 can make arrangements such as repair of the automatic driving vehicle 1.

On the other hand, when it is determined in step S110 that there is no abnormality in the diagnosis result of the daily inspection (that is, the determination No. in step S110), the inspection apparatus 10 ends the process.

Subsequently, the processing performed by the manager of the automatic driving vehicle 1 (that is, the central management center 60, the business operator 70 of the car sharing business etc., or the user 80) will be described with reference to the flowchart of FIG. 6.

First, in step S210, the central control center 60 receives the diagnosis result of the daily inspection transmitted from the inspection apparatus 10. Next, in step S220, the central management center 60 analyzes the received diagnosis result. Subsequently, in step S230, the central management center 60 determines whether or not there is an abnormality in each function and device of the automatic driving vehicle 1. When it is determined that there is no abnormality in each function and device of the automatic driving vehicle 1 (that is, the determination No. in step S230), the process is ended.

On the other hand, when it is determined in step S230 that each function and device of the automatic driving vehicle 1 has an abnormality (that is, the determination Yes in step S230), the process is shifted to step S240. In step S240, the central management center 60 notifies the business operator 70 and the user 80 of the car sharing business etc., that there is an abnormality in each function and device of the automatic driving vehicle 1. Specifically, the central management center 60 transmits the information to the transceiver 90 held by the business operator 70 or the user 80.

Subsequently, in step S250, the business operator 70 and the user 80 of the car sharing business etc., determine whether or not it is necessary to request a repair company to repair the automatic driving vehicle 1. When the repair company is not requested to repair the automatic driving vehicle 1 (that is, the determination No. in step S250), the process is ended. On the other hand, when requesting the repair company to repair the automatic driving vehicle 1 (that is, the determination Yes in step S250), the process is shifted to step S260.

In step S260, it is determined whether or not the automatic driving vehicle 1 is capable of automatically traveling. When it is determined that the automatic driving vehicle 1 is capable of automatic traveling (that is, the determination Yes in step S260), the automatic driving vehicle 1 travels to the repair company by automatic driving. Then, in step S270, the repair company repairs the automatic driving vehicle 1, and the process is ended.

On the other hand, when it is determined in step S260 that the automatic driving vehicle 1 cannot travel automatically (that is, the determination No. in step S260), the process is shifted to step S280. A tow truck is arranged in step S280, and the automatic driving vehicle 1 is carried by the tow truck to a repair company. Subsequently, in step S290, the repair company repairs the automatic driving vehicle 1, and the process is ended.

In addition, the business operator 70 and the user 80 of the car sharing business etc., may go to pick up the automatic driving vehicle 1 by themselves. Further, the business operator 70 and the user 80 of the car sharing business etc., may determine whether or not repair is necessary after returning the automatic driving vehicle 1 to themselves instead of moving to the repair company.

automatic daily inspection system of the first embodiment described above provides the following effects.

(1) The automatic daily inspection apparatus 10 provided in the automatic daily inspection system of the first embodiment performs a daily inspection of the automatic driving vehicle 1 at a predetermined point of time, and transmits the inspection diagnosis result to the transceiver 90 held by the manager of the automatic driving vehicle 1. According to this, the manager of the automatic driving vehicle 1 can use the automatic driving vehicle 1, which has been subjected to the daily inspection, with sense of security. For example, when the automatic driving vehicle 1 is used for a car sharing business etc., accidents and breakdowns due to insufficient daily inspection of the automatic driving vehicle 1 can be prevented even if the business operator 70 and the user 80 do not perform a daily inspection by themselves. In addition, the business operator 70 and the owner can lend the vehicle after checking and inspecting the vehicle condition, and can prepare for a proceeding, compensation, and insurance in case of emergency. That is, if an accident or breakdown occurs while the automatic driving vehicle 1 is traveling, the cause of insufficient daily inspection is eliminated from the causes of the accident or breakdown. Therefore, this automatic daily inspection system has high utility value not only to the manager of the automatic driving vehicle 1 but also to an insurance company or the like having an insurance contract with the manager of the automatic driving vehicle 1.

(2) In the first embodiment, the automatic daily inspection apparatus 10 automatically performs a daily inspection related to the devices including an automatic operation system that executes automatic driving. By the way, in the daily inspection of the devices affecting the acceleration, steering, and braking of the automatic driving vehicle 1, it is considered that the safety confirmation is insufficient by a known daily inspection performed by a person. In this regard, the automatic daily inspection apparatus 10 automatically performs the daily inspection including the devices used for automatic driving, and transmits the diagnosis result to the manager who manages the automatic driving vehicle 1. Therefore, the manager of the automatic driving vehicle 1 can use the automatic driving vehicle 1 that has been inspected on a daily basis with sense of security.

(3) In the first embodiment, when the automatic driving vehicle 1 is used for a car sharing business etc., the predetermined point of time at which the automatic daily inspection apparatus 10 performs the daily inspection is a point of time at which the user 80 of the automatic driving vehicle 1 is changed, or a point of time at which the use by the user 80 is completed. According to this, when the automatic driving vehicle 1 is used for a car sharing business etc., it is possible to avoid a situation in which the automatic driving vehicle 1 cannot be used due to insufficient daily inspection after the user 80 calls the automatic driving vehicle 1 via communication or the like by automatic driving.

In addition, when an abnormality is determined by the daily inspection, it becomes clear who (i.e., which user 80) was in the vehicle when the abnormality occurred. Further, even if the automatic driving vehicle 1 is used for a car sharing business etc., and an accident or breakdown occurs while driving, the lack of daily inspection by the business operator 70 and the user 80 may be eliminated from the cause of the accident or breakdown. Therefore, this automatic daily inspection system has high utility value not only to the manager of the automatic driving vehicle 1 but also to an insurance company or the like having an insurance contract with the manager of the automatic driving vehicle 1.

(4) In the first embodiment, the targets to be inspected daily by the automatic daily inspection apparatus 10 include a device, which is difficult to inspect while driving and is inspected while the vehicle is stopped, among the devices used for the automatic driving of the automatic driving vehicle 1. According to this, the manager can use the automatic driving vehicle 1 with sense of security by performing daily inspections of the devices used for the automatic driving of the automatic driving vehicle 1 while the automatic driving vehicle 1 is stopped.

(5) In the first embodiment, the targets to be inspected daily by the automatic daily inspection apparatus 10 include at least one of the automatic traveling camera 21, the automatic traveling radar 23, and the steering device 22, which are used for the automatic driving of the automatic driving vehicle 1. According to this, the manager can use the automatic driving vehicle 1 with sense of security by performing daily inspections on important devices used for the automatic driving of the automatic driving vehicle 1 without hindering the traveling of the automatic driving vehicle 1.

(6) In the first embodiment, the manager to whom the automatic daily inspection apparatus 10 transmits the diagnosis result is the business operator 70 who conducts the car sharing business etc., of the automatic driving vehicle 1, the user 80 of the automatic driving vehicle 1, or the central management center 60. According to this, when the automatic driving vehicle 1 is used for a car sharing business etc., the manager involved in the business can use the automatic driving vehicle 1 which has been subjected to the daily inspection, with sense of security.

(7) In the first embodiment, the automatic daily inspection apparatus 10 transmits all of the diagnosis result to the central management center 60, and transmits the abnormality determination of the diagnosis result to the business operator 70 who conducts the car sharing business of the automatic driving vehicle 1 or the user 80. According to this, since the central management center 60 can grasp all the diagnosis result of the daily inspection of the automatic driving vehicle 1, the safety of the automatic driving vehicle 1 can be further enhanced. Further, when the business operator 70 and the user 80 receive the abnormality determination of the daily inspection of the automatic driving vehicle 1, they can avoid using the automatic driving vehicle 1 and use another automatic driving vehicle 1. In addition, if there is an abnormality determination in the daily inspection of the automatic driving vehicle 1, the manager can promptly deal with it.

(8) In the first embodiment, the central management center 60 determines whether or not there is an abnormality in the automatic driving vehicle 1 based on the diagnosis result of the daily inspection received from the automatic daily inspection apparatus 10. Then, when the central management center 60 determines that there is an abnormality in the automatic driving vehicle 1, it transmits the diagnosis result to the transceiver 90 of the business operator 70 who conducts the car sharing business etc., of the automatic driving vehicle 1 or the user 80 thereof. According to this, the business operator 70 and the user 80 can make arrangements such as repair of the automatic driving vehicle 1 according to the diagnosis result of the daily inspection.

(9) In the first embodiment, the automatic daily inspection apparatus 10 displays the diagnosis result of the daily inspection on the in-vehicle monitor 50 mounted on the automatic driving vehicle 1. According to this, the manager of the automatic driving vehicle 1 can also know the diagnosis result of the daily inspection by directly looking at the in-vehicle monitor 50 mounted on the automatic driving vehicle 1.

### Second Embodiment

A second embodiment will be described. The second embodiment is similar to the first embodiment except for the configuration of the automatic driving vehicle 1 partially modified from the first embodiment. Accordingly, only parts different from the first embodiment are herein described.

As shown in FIG. 7, in the second embodiment, the automatic driving vehicle 1 is provided with various functions. Among them, the automatic inspection function 61 may include a plurality of functions such as an automatic continuous inspection and an automatic daily inspection. The automatic continuous inspection means an inspection that is automatically performed while the automatic driving vehicle 1 is traveling. On the other hand, the automatic daily inspection refers to an inspection that is automatically performed while the automatic driving vehicle 1 is stopped for inspecting items that cannot be inspected while the automatic driving vehicle 1 is traveling.

The automatic daily inspection apparatus 10 automatically performs an automatic continuous inspection and an automatic daily inspection of the automatic driving vehicle 1, and notifies the manager of the automatic driving vehicle 1 of the diagnosis result. According to this, the manager of the automatic driving vehicle 1 can use the automatic driving vehicle 1 with sense of security. Therefore, the second embodiment can also exhibit the same operation and effects as those of the first embodiment.

### Third to Sixth Embodiments

Third to sixth embodiments will be described. In the third to sixth embodiments, the point of time at which the automatic daily inspection apparatus 10 performs a daily inspection of the automatic driving vehicle 1 is changed with respect to the first embodiment and the like, and the other parts are the same as those in the first embodiment and the like. Therefore, the third to sixth embodiments will be described only with respect to the parts different from the first embodiment and the like. In the following description, the automatic daily inspection apparatus 10 may be simply referred to as an “inspection apparatus 10”.

### Third Embodiment

The control process performed by the inspection apparatus 10 of the third embodiment will be described with reference to the flowchart of FIG. 8. In the third embodiment, the processing in steps S10 and S20 described in the first embodiment are abolished.

In the third embodiment, first, in step S30, when the traveling switch of the automatic driving vehicle 1 is turned on, the inspection apparatus 10 performs a daily inspection of each function and device included in the automatic driving vehicle 1. This daily inspection is performed while the automatic driving vehicle 1 is stopped. The processing from step S40 to step S70 is the same as that described in the first embodiment.

In step S80, the inspection apparatus 10 determines whether or not the use of the automatic driving vehicle 1 is completed, that is, whether or not the traveling switch of the automatic driving vehicle 1 is turned off. This process is continuously performed until the traveling switch of the automatic driving vehicle 1 is turned off. When it is determined that the travel switch of the automatic driving vehicle 1 is turned off (that is, the determination Yes in step S80), the process is shifted to step S90, to perform a daily inspection. After that, the processing in steps S90 to S110 is also the same as the processing described in the first embodiment.

In the third embodiment described above, the predetermined point of time at which the inspection apparatus 10 performs a daily inspection is a point of time at which the traveling switch of the automatic driving vehicle 1 is turned on and a point of time at which the traveling switch is turned off. According to this, since the daily inspection is performed immediately before the traveling of the automatic driving vehicle 1, the manager can use the automatic driving vehicle 1 with sense of security. In addition, since the daily inspection is performed immediately after the automatic driving vehicle 1 is traveling, the manager can grasp whether or not an abnormality has occurred during the traveling immediately before that. Then, when an abnormality is determined in the daily inspection after the vehicle has traveled, the manager can repair the vehicle before the next travel.

### Fourth Embodiment

The control process performed by the inspection apparatus 10 of the fourth embodiment will be described with reference to the flowchart of FIG. 9. In the fourth embodiment, the processing in steps S11 and S21 is incorporated in place of the processing in steps S10 and S20 described in the first embodiment.

In the fourth embodiment, the inspection apparatus 10 acquires the current time (i.e., clock time) in step S11. Then, in step S21, the inspection apparatus 10 determines whether or not the current time is a predetermined time. The predetermined time is the time when a predetermined period of time has elapsed since the previous daily inspection. When it is determined that the current time has reached the predetermined time (that is, the determination Yes in step S21), the process is shifted to step S30, to perform a daily inspection. After that, the processing in steps S30 to S60 is the same as the processing described in the first embodiment. In the fourth embodiment, the processing in steps S70 to S110 described in the first embodiment is abolished.

In the fourth embodiment described above, the predetermined point of time at which the automatic daily inspection apparatus 10 performs a daily inspection is a point of time at which a predetermined period of time has elapsed since the previous daily inspection. According to this, the automatic daily inspection apparatus 10 can periodically perform daily inspections of the automatic driving vehicle 1 with predetermined time intervals.

### Fifth Embodiment

The control process performed by the inspection apparatus 10 of the fifth embodiment will be described with reference to the flowchart of FIG. 10. In the fifth embodiment, the processing in step S22 is incorporated in place of the processing in steps S10 and S20 described in the first embodiment.

In the fifth embodiment, in step S22, the inspection apparatus 10 determines whether or not the automatic driving vehicle 1 is being replenished (i.e., under replenishment) with energy (for example, electricity, hydrogen, gasoline) necessary for traveling. When it is determined that the automatic driving vehicle 1 is being replenished with energy (that is, the determination Yes in step S22), the process is shifted to step S30, to perform a daily inspection. After that, the processing in steps S30 to S60 is the same as the processing described in the first embodiment. Also in the fifth embodiment, the processing in steps S70 to S110 described in the first embodiment is abolished.

In the fifth embodiment described above, the predetermined point of time at which the automatic daily inspection apparatus 10 performs a daily inspection is a point of time at which the energy required for the traveling of the automatic driving vehicle 1 is being replenished. According to this, the automatic daily inspection apparatus 10 can perform a daily inspection within a certain mileage of the automatic driving vehicle 1. Further, in general, when the automatic driving vehicle 1 is being replenished with energy, the automatic driving vehicle 1 is stopped. Therefore, the automatic daily inspection apparatus 10 can perform a daily inspection while the automatic driving vehicle 1 is stopped for inspecting items that cannot be inspected while the automatic driving vehicle 1 is traveling.

### Sixth Embodiment

The control process performed by the inspection apparatus 10 of a sixth embodiment will be described with reference to the flowchart of FIG. 11. In the sixth embodiment, the processing in steps S13 and S23 is incorporated in place of the processing in steps S10 and S20 described in the first embodiment.

In the sixth embodiment, in step S13, the inspection apparatus 10 acquires the current mileage (i.e., traveled distance). Then, in step S23, the inspection apparatus 10 determines whether or not the current mileage is a predetermined distance. The predetermined distance is a distance obtained by adding a certain distance onto the mileage at the previous daily inspection. When it is determined that the current mileage has reached a predetermined distance (that is, the determination Yes in step S23), the process is shifted to step S30, to perform a daily inspection. After that, the processing in steps S30 to S60 is the same as the processing described in the first embodiment. Also in the sixth embodiment, the processing in steps S70 to S110 described in the first embodiment is abolished.

In the sixth embodiment described above, the predetermined point of time at which the automatic daily inspection apparatus 10 performs a daily inspection is a point of time at which the vehicle has traveled a certain distance from the previous daily inspection. According to this, the automatic daily inspection apparatus 10 can perform a daily inspection every fixed mileage of the automatic driving vehicle 1.

### Other Embodiments

The present disclosure is not limited to the embodiments described above, and can be modified as appropriate. The above embodiments are not independent of each other, and can be appropriately combined except when the combination is obviously impossible. Individual elements or features of a particular embodiment are not necessarily essential unless it is specifically stated that the elements or the features are essential in the foregoing description, or unless the elements or the features are obviously essential in principle. Further, in each of the embodiments described above, when numerical values such as the number, numerical value, quantity, range, and the like of the constituent elements of the embodiment are referred to, except in the case where the numerical values are expressly indispensable in particular, the case where the numerical values are obviously limited to a specific number in principle, and the like, the present disclosure is not limited to the specific number. Further, in each of the embodiments described above, when referring to the shape, positional relationship, and the like of the elements and the like, it is not limited to the shape, positional relationship, and the like, except for the case where the elements are specifically specified, the case where the elements are fundamentally limited to a specific shape, positional relationship, and the like. The controller and the method thereof described in the present disclosure may be implemented (i) by (a) a first special-purpose computer provided by configuring a processor and a memory programmed to execute one or more functions embodied by a computer program product, or (ii) by (b) a second special-purpose computer provided by configuring a processor with one or more special-purpose hardware logic circuits, or (iii) any combination of (a) the first special-purpose computer provided by configuring the processor and the memory and (b) the second special-purpose computer provided by configuring the processor with one or more special-purpose hardware logic circuits. The computer programs may be stored, as instructions to be executed by a computer, in a tangible non-transitory computer-readable storage medium. The controller is an automatic daily inspection apparatus 10, while the method thereof is an automatic daily inspection function 6 and an automatic daily inspection function 61.

(1) In each of the above embodiments, the automatic driving vehicle 1 in which the automatic daily inspection system performs a daily inspection is described as assuming that the automatic driving system performs all driving operations such as acceleration, steering, braking, and monitoring of the surroundings. However, it is not limited to this. In another embodiment, the automatic driving vehicle 1 may be an automobile capable of switching between an automatic driving mode in which the automobile automatically travels and a manual driving mode in which the automobile travels by the driving operation of an occupant.

Further, in another embodiment, the automatic driving vehicle 1 may be an automobile capable of executing automatic driving in a driving mode corresponding to a predetermined automatic driving degree selected from a plurality of predetermined automatic driving degrees. In that case, the automatic driving system switches the automatic driving degree by a well-known method based on the detection signals of various sensors. For example, the automatic driving system switches the degree of automatic driving based on the surrounding environment of the vehicle and the operation of the occupant. The degree of automatic driving indicates the degree to which the driving operation depends on the automatic driving system mounted on the vehicle.

(2) In each of the above embodiments, the automatic daily inspection system has been described as performing a daily inspection of the automatic driving vehicle 1, but the there is no need to be limited to this. In another embodiment, the automatic daily inspection system may be one that performs a daily inspection of the automobile traveling by the driving operation of the occupant.

(3) In each of the above embodiments, the automatic daily inspection system has been described as performing daily inspections of the automatic traveling camera 21, the steering device 22, the air conditioning device 30, various sensors 40, etc., included in the automatic driving vehicle 1. There is no need to be limited to this. In another embodiment, the automatic daily inspection system includes various common routines such as, for example, the amount of brake fluid, the amount of cooling water, the amount of battery fluid, the lighting of lamps, the tire pressure, etc., of the automatic driving vehicle 1. The inspection items may be inspected automatically.

For reference to further explain features of the present disclosure, the description is added as follows.

Automatic driving vehicles are expected to be used in a car sharing business or automatic rental business (hereinafter referred to as car sharing business, etc.). In addition, since automatic driving vehicles can automatically drive to their destinations, it is expected in the future that they will be used not only by an owner who has a driver's license but also by an owner who does not have a driver's license.

In cases that an automatic driving vehicle is used for a car sharing business, etc., if a user uses the vehicle for a long period of time, it is conceivable that the parking period of the vehicle at the place where the business operator is located will be shortened. In such a case, it is difficult for the business operator to carry out daily inspections of the automatic driving vehicle every time the user of the automatic driving vehicle changes. In addition, it is difficult to impose the obligation of daily inspection on all users because some users of car sharing business etc., may be unfamiliar with daily inspection. Therefore, it is conceivable that problems will arise in daily inspections of automatic driving vehicles that are used differently than before, such as in car sharing businesses, etc.

In addition, when an automatic driving vehicle is used by an owner who does not have a driver's license, it is assumed that such an owner is unfamiliar with the daily inspection of the automatic driving vehicle. In that case, it is conceivable that a known daily inspection performed by a person be insufficient for the safety confirmation of the automatic driving vehicle. This is considered to be a major problem, especially for daily inspections of automatic driving systems that affect the running, turning, and stopping of automatic driving vehicles.

If an accident or breakdown occurs while the automatic driving vehicle is traveling, whether it was caused by lack of daily inspection or not is important for business operators and users of car sharing businesses etc., vehicle owners, and insurance companies that have insurance contracts with them.

By the way, there is a vehicle failure diagnosis apparatus that performs failure diagnosis of an electronic control device mounted on a vehicle. This vehicle failure diagnosis apparatus is used at a dealer's service station or the like, and it is possible to collect data related to the electronic control device by performing a road test of the vehicle under the state where the vehicle failure diagnosis apparatus is connected to the electronic control device of the vehicle.

However, the vehicle failure diagnosis apparatus described above is used at a service station of a dealer or the like. When it is used, specialized knowledge is required, and a vehicle road test is also required. Therefore, it is difficult for the apparatus described above to be used by business operators or users of car-sharing businesses etc., or owners who do not have driver's licenses, for daily inspections of automatic driving vehicles. Further, if an accident or breakdown occurs while the automatic driving vehicle is traveling, it is difficult to use the apparatus described above to determine whether or not such an accident or the like is caused by the lack of daily inspection.

It is thus desired to provide an automatic daily inspection system that enables an automobile to be used with a sense of security by automatically performing a daily inspection of the automobile.

Aspects of the present disclosure described herein are set forth in the following clauses.

According to a first aspect indicated in some or all of the above-described embodiments, an automatic daily inspection system that automatically performs a daily inspection of the automobile is provided to include an automatic daily inspection apparatus mounted on the automobile. The automatic daily inspection apparatus is configured to perform a daily inspection on the automobile at a predetermined point of time, and transmit a diagnosis result of the daily inspection to a transceiver held by a manager who manages the automobile.

As a result, the automatic daily inspection apparatus automatically performs the daily inspection of the automobile at a predetermined point of time, and the diagnosis result is transmitted to the manager who manages the automobile. Examples of the manager include a business operator who conducts a car sharing business of an automobile, a user of an automobile, an owner of an automobile, or a central management center. The diagnosis result of the daily inspection by the automatic daily inspection apparatus is sent to the manager. Even if it is difficult for the manager to perform the daily inspection, the manager can use the automobile that has been automatically inspected with confidence. For example, when an automobile is used for a car sharing business etc., an accident or breakdown due to insufficient daily inspection of the automobile can be prevented even if the business operator and the user do not carry out daily inspection by themselves. Further, even if an accident or breakdown occurs while the automobile is traveling, the insufficient daily inspection may be eliminated from the cause of the accident or breakdown. Therefore, this automatic daily inspection system is highly useful not only for automobile managers but also for insurance companies and the like that have insurance contracts with the managers.

According to a second aspect, the automatic daily inspection apparatus is mounted in an automatic driving vehicle; and the automatic daily inspection apparatus is configured to automatically perform the daily inspection on devices including an automatic driving system that executes automatic driving. By the way, it is considered that the safety confirmation by a known daily inspection performed by a person is insufficient for the daily inspection of the devices that affect running, turning, and stopping of the automatic driving vehicle. In this regard, the automatic daily inspection apparatus automatically performs daily inspections for the devices including devices used for automatic driving, and transmits the diagnosis result to the manager who manages the automobile. Therefore, for example, even when the automatic driving vehicle is used for a car sharing business etc., or even when it is used by an owner who does not have a license, the manager of the automatic driving vehicle can use the automatic driving vehicle that has been inspected on a daily basis with sense of security.

According to a third aspect, the manager who manages the automobile includes a user of the automobile; and in cases that the automobile is used for a car sharing business or an automatic rental business, the predetermined point of time at which the automatic daily inspection apparatus performs the daily inspection is a point of time at which the user of the automobile is changed, or a point of time at which the user ends using the automobile. According to this, when an automatic driving vehicle is used for a car sharing business, etc., it is possible to avoid a situation where after a user calls an automatic driving vehicle by communication or the like, the automatic driving vehicle cannot be used due to insufficient daily inspection. In addition, in cases that an abnormality in the automatic driving vehicle is determined by the daily inspection, it is possible to know who (i.e., which user) was using the vehicle when the abnormality occurred in the vehicle. In addition, business operators or owners can check and inspect the vehicle condition before lending, and can prepare for proceedings, compensation, and insurance in case of emergency. That is, even if an accident or breakdown occurs during driving, the lack of daily inspection by the business operator or the user is eliminated from the cause of the accident or breakdown. Therefore, this automatic daily inspection system is highly useful not only for the manager of the automatic driving vehicle but also for the insurance company and the like who have an insurance contract with the manager of the automatic driving vehicle.

According to a fourth aspect, the predetermined point of time at which the automatic daily inspection apparatus performs the daily inspection is a point of time at which a traveling switch of the automobile is turned on or off. According to this, when the daily inspection is performed at the point of time at which the travel switch of the automobile is turned on, the daily inspection is performed immediately before the vehicle travels, so that the manager can use the automobile with sense of security. In addition, if the daily inspection is performed at the point of time at which the driving switch of the automobile is turned off, the daily inspection is performed immediately after the vehicle has completed traveling. Therefore, the manager can grasp whether or not an abnormality has occurred during the traveling immediately before that. Then, when an abnormality is determined in the daily inspection after the vehicle has completed traveling, the manager can repair the vehicle before the next traveling.

According to a fifth aspect, the predetermined point of time at which the automatic daily inspection apparatus performs the daily inspection is a point of time at which a predetermined period of time has elapsed since the daily inspection previously performed. According to this, the automatic daily inspection apparatus can periodically perform a daily inspection of the automobile at predetermined time intervals.

According to a sixth aspect, the predetermined point of time at which the automatic daily inspection apparatus performs the daily inspection is a point of time at which an energy required for traveling of the automobile is being replenished. According to this, the automatic daily inspection apparatus can perform a daily inspection within a certain mileage of the automobile. Also, in general, the automobile is being stopped when the automobile is being replenished with energy. Therefore, the automatic daily inspection apparatus can perform daily inspections while the automatic driving vehicle is stopped for inspecting items that cannot be inspected while the automobile is traveling.

According to a seventh aspect, a target to be inspected daily by the automatic daily inspection apparatus includes, among devices used for automatic driving of the automatic driving vehicle, a device that is difficult to inspect while driving of the automobile and is enabled to be inspected while the automobile is being stopped. According to this, it is possible to carry out daily inspections of the device used for the automatic driving of the automatic driving vehicle while the automatic driving vehicle is being stopped.

According to an eighth aspect, a target to be inspected daily by the automatic daily inspection apparatus includes at least one of an automatic traveling camera, an automatic traveling radar, and a steering device, which are used for the automatic driving of the automatic driving vehicle. According to this, managers can use automatic driving vehicles with sense of security by conducting daily inspections of important devices used for automatic driving of automatic driving vehicles without hindering the driving of automatic driving vehicles.

According to a ninth aspect, the manager to whom the automatic daily inspection apparatus transmits the diagnosis result includes a business operator engaged in a car sharing business or an automatic rental business of the automobile, a user of the automobile, or a central management center that manages the automobile. According to this, when an automobile is used for a car sharing business etc., the manager involved in the business can use the automobile with sense of security.

According to a tenth aspect, the automatic daily inspection apparatus is configured to transmit all of the diagnosis result to the central management center, and transmit an abnormality determination included in the diagnosis result to the business operator or the user. According to this, the central management center can grasp all the diagnosis result of the daily inspection of the automobile, so that the safety of the automatic driving vehicle can be further improved. In addition, when the business operator and the user receive the abnormality determination of the daily inspection of the automobile, they can avoid using the automobile and use another automobile.

According to an eleventh aspect, in cases that the central management center determines that there is an abnormality in the automobile based on the diagnosis result received from the automatic daily inspection apparatus, the central management center is configured to transmit the diagnosis result to the transceiver held by the business operator or the user. According to this, the business operator and the user can make arrangements such as repair of the automobile according to the diagnosis result.

According to a twelfth aspect, the automatic daily inspection apparatus is configured to display the diagnosis result on an in-vehicle monitor mounted on the automobile. According to this, the manager of the automobile can also know the diagnosis result of the daily inspection by directly looking at the in-vehicle monitor mounted on the automobile.

What is claimed is:

1. An automatic daily inspection system that automatically performs a daily inspection of an automobile, comprising:
an automatic daily inspection apparatus mounted on the automobile, the automatic daily inspection apparatus being configured to perform a daily inspection on the automobile at a predetermined point of time, and transmit a diagnosis result of the daily inspection to a transceiver held by a manager who manages the automobile.

2. The automatic daily inspection system according to claim 1, wherein:
the automatic daily inspection apparatus is mounted in an automatic driving vehicle; and
the automatic daily inspection apparatus is configured to automatically perform the daily inspection on devices including an automatic driving system that executes automatic driving.

3. The automatic daily inspection system according to claim 1, wherein:
the manager who manages the automobile includes a user of the automobile; and
in cases that the automobile is used for a car sharing business or an automatic rental business, the predetermined point of time at which the automatic daily inspection apparatus performs the daily inspection is a point of time at which the user of the automobile is changed, or a point of time at which the user ends using the automobile.

4. The automatic daily inspection system according to claim 1, wherein:
the predetermined point of time at which the automatic daily inspection apparatus performs the daily inspection is a point of time at which a traveling switch of the automobile is turned on or off.

5. The automatic daily inspection system according to claim 1, wherein:
the predetermined point of time at which the automatic daily inspection apparatus performs the daily inspection is a point of time at which a predetermined period of time has elapsed since the daily inspection previously performed.

6. The automatic daily inspection system according to claim 1, wherein:
the predetermined point of time at which the automatic daily inspection apparatus performs the daily inspection is a point of time at which an energy required for traveling of the automobile is being replenished.

7. The automatic daily inspection system according to claim 2, wherein:
a target to be inspected daily by the automatic daily inspection apparatus includes, among the devices used for the automatic driving of the automatic driving vehicle, a device that is difficult to inspect while driving of the automobile and is enabled to be inspected while the automobile is stopped.

8. The automatic daily inspection system according to claim 2, wherein:
a target to be inspected daily by the automatic daily inspection apparatus includes at least one of an automatic traveling camera, an automatic traveling radar, and a steering device, which are used for the automatic driving of the automatic driving vehicle.

9. The automatic daily inspection system according to claim 1, wherein:
the manager to whom the automatic daily inspection apparatus transmits the diagnosis result includes a business operator engaged in a car sharing business or an automatic rental business of the automobile, a user of the automobile, or a central management center that manages the automobile.

10. The automatic daily inspection system according to claim 9, wherein:
the automatic daily inspection apparatus is configured to transmit all of the diagnosis result to the central management center, and transmit an abnormality determination included in the diagnosis result to the transceiver held by the business operator or the user.

11. The automatic daily inspection system according to claim 9, wherein:
in cases that the central management center determines that there is an abnormality in the automobile based on the diagnosis result received from the automatic daily inspection apparatus, the central management center is configured to transmit the diagnosis result to the transceiver held by the business operator or the user.

12. The automatic daily inspection system according to claim 1, wherein:
the automatic daily inspection apparatus is configured to display the diagnosis result on an in-vehicle monitor mounted on the automobile.
